(19) United States
(12) Patent Application Publication
(10) Pub. No.: US 2013/0155306 A1
(43) Pub. Date: Jun. 20, 2013

(54) IMAGE CAPTURING DEVICE HAVING AN EXPANSION DOCK

(71) Applicants: Hung-Chi Tung, New Taipei City (TW); Chia-Hsin Tsai, New Taipei City (TW); Yu-Cheng Chang, New Taipei City (TW); Po-Hung Lin, New Taipei (TW); Shou-Min Hung, New Taipei City (TW)

(72) Inventors: Hung-Chi Tung, New Taipei City (TW); Chia-Hsin Tsai, New Taipei City (TW); Yu-Cheng Chang, New Taipei City (TW); Po-Hung Lin, New Taipei (TW); Shou-Min Hung, New Taipei City (TW)

(21) Appl. No.: 13/437,559

(22) Filed: Apr. 2, 2012

(30) Foreign Application Priority Data
Dec. 14, 2011 (TW) 100223607

(51) Int. Cl. H04N 5/222; H04N 5/225

(52) U.S. Cl. 348/333.01; 348/375; 348/E05.048

(57) ABSTRACT

The present invention relates to a image capturing device having an expansion dock, which comprises: an image capturing device having a first connector; an expansion dock having a second connector for being connected with the first connector; a display device; a printed circuit board; and a drive unit; thereby enabling the image data captured by the image capturing device to be displayed on the display device or to be transmitted by a wireless communication module through connecting the first connector and the second connector.

### BACKGROUND OF THE INVENTION

1. Field of the Invention

The present invention relates to an image capturing device, especially to an image capturing device having an expansion dock.

2. Description of Related Art

A low-end image capturing device seen in the marketplace, e.g. a digital camera, is aimed at low price section and the capacity of built-in flash memory is small and is not be equipped with a display device for viewing. As such, after an image is taken, if the image data is desired to be displayed, a USB cable is required to upload the image data in the flash memory to a personal computer for displaying.

A middle-end image capturing device seen in the market place is often equipped with a display device for display the image data, but not equipped with functions of wireless communication or satellite navigation. As such, the device is still not convenient in use, and shall be improved.

In view of the disadvantages of a conventional image capturing device, the present invention provides an image capturing device having an expansion dock for improving the disadvantages

### SUMMARY OF THE INVENTION

One primary objective of the present invention is to provide an image capturing device having an expansion dock, which is installed with an expansion dock capable of being combined with the image capturing device, and the expansion dock has a display device for displaying the image data captured by the image capturing device on the display device.

Another objective of the present invention is to provide an image capturing device having an expansion dock, which is installed with an expansion dock capable of being combined with the image capturing device, and the expansion dock has a wireless communication module, such that the image data captured by the image capturing device can be transmitted through the wireless communication module.

One another objective of the present invention is to provide an image capturing device having an expansion dock, which is installed with an expansion dock capable of being combined with the image capturing device, and the expansion dock can be combined with a supporter.

For achieving the objectives, the present invention provides an image capturing device having an expansion dock, which comprises: an image capturing device having a rail at the bottom and a first connector on one lateral wall; an expansion dock formed with an accommodation space, and having a guide slot at one lateral side of the bottom for allowing the rail to be sleeved in thereby accommodating the image capturing device, and one lateral wall of the expansion dock is installed with a second connector for being connected with the first connector, and the other lateral wall of the expansion dock is hollow; a display device disposed on the lateral wall; a printed circuit board disposed on the expansion dock; and a drive unit disposed on the printed circuit board and respectively coupled to the display device and the second connector; thereby enabling the image data captured by the image capturing device to be displayed on the display device through connecting the first connector and the second connector.

For achieving the objectives, the present invention provides an image capturing device having an expansion dock, which comprises: an image capturing device having a rail at the bottom and a first connector on one lateral wall; an expansion dock formed with an accommodation space, and having a guide slot at one lateral side of the bottom for allowing the rail to be sleeved in thereby accommodating the image capturing device, and one lateral wall of the expansion dock is installed with a second connector for being connected with the first connector; a printed circuit board disposed on the expansion dock; and a wireless communication module disposed on the printed circuit board and coupled to the second connector; thereby enabling the image data captured by the image capturing device to be transmitted by the wireless communication module through connecting the first connector and the second connector.

For achieving the objectives, the present invention provides an image capturing device having an expansion dock, which comprises: an image capturing device having a rail at the bottom and a first connector on one lateral wall; an expansion dock formed with an accommodation space, and having a guide slot at one lateral side of the bottom for allowing the rail to be sleeved in thereby accommodating the image capturing device, and one lateral wall of the expansion dock is installed with a second connector for being connected with the first connector; and a supporter with one end fastened on a support base for supporting the image capturing device.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic exploded view illustrating the image capturing device having an expansion dock according to one preferred embodiment of the present invention;

FIG. 2 is a schematic view illustrating the assembly of the image capturing device having an expansion dock according to one preferred embodiment of the present invention;

FIG. 3 is another schematic view illustrating the assembly of the image capturing device having an expansion dock according to one preferred embodiment of the present invention;

FIG. 4 is a schematic exploded view illustrating the image capturing device having an expansion dock according to another preferred embodiment of the present invention; and

FIG. 5 is a schematic view illustrating the assembly of the image capturing device having an expansion dock according to another preferred embodiment of the present invention.

### DETAILED DESCRIPTION OF THE PREFERRED EMBODIMENT

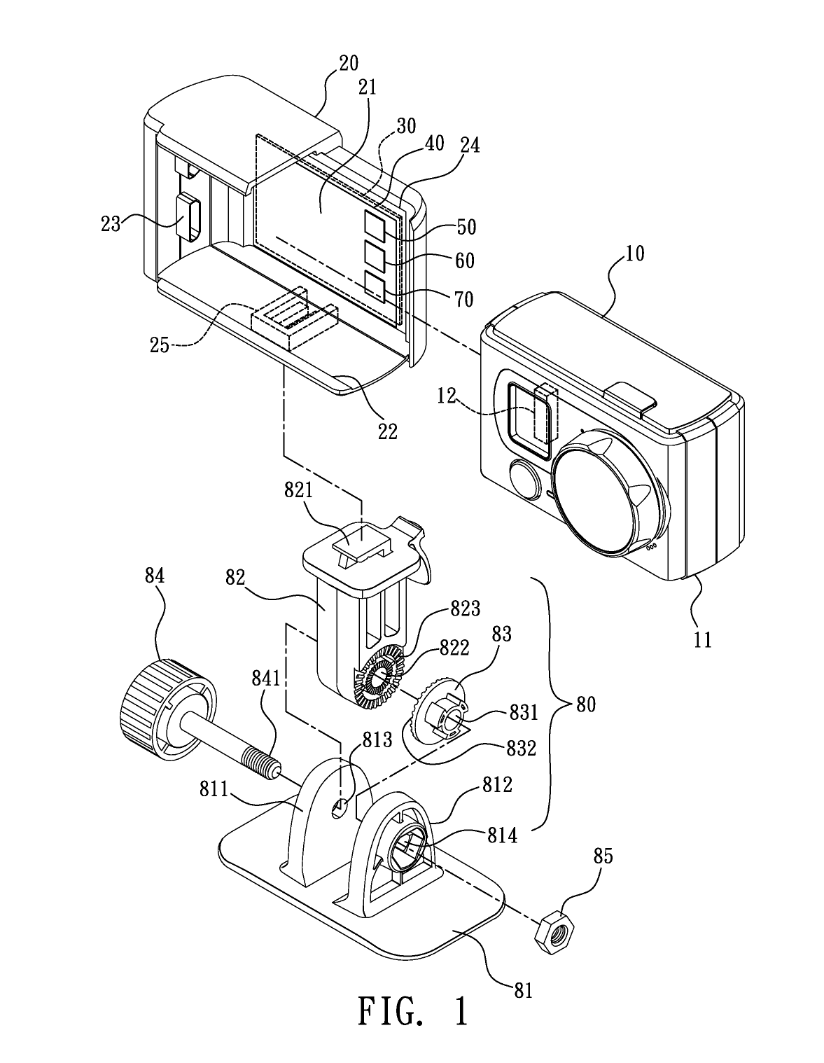

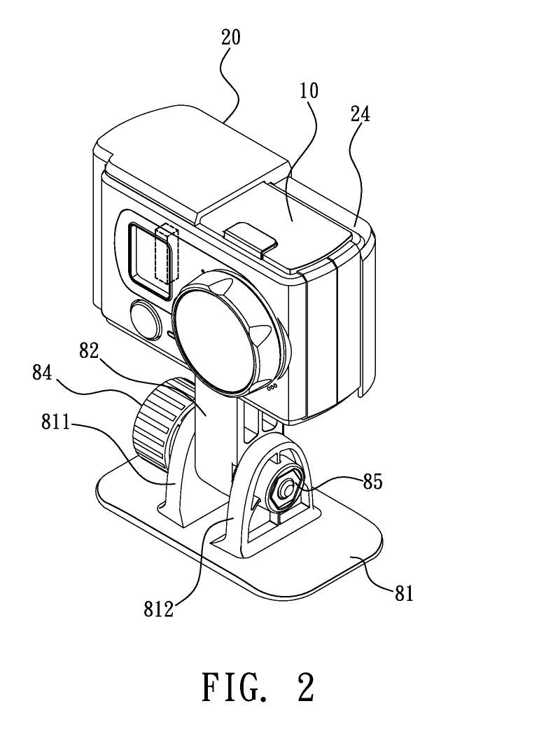

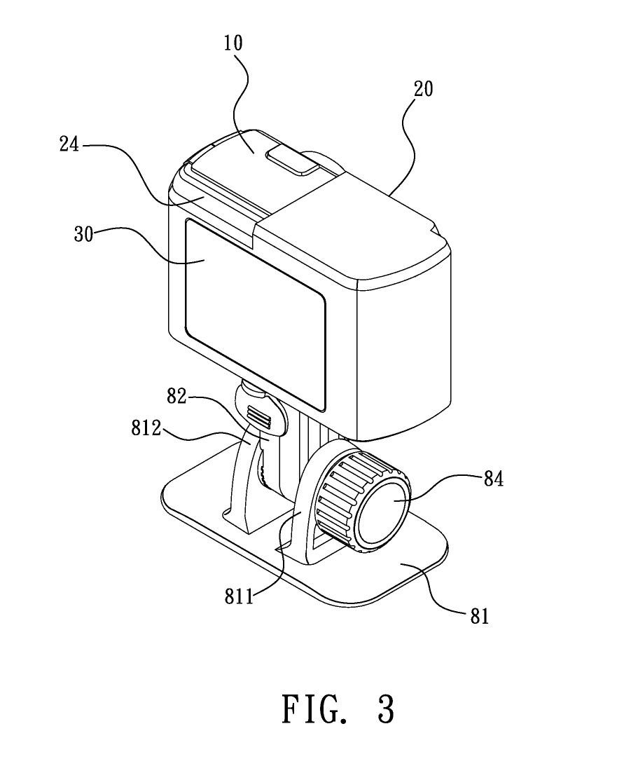

Referring from FIG. 1 to FIG. 3, wherein FIG. 1 is a schematic exploded view showing the image capturing device having an expansion dock according to one preferred embodiment of the present invention; FIG. 2 is a schematic view showing the assembly of the image capturing device having an expansion dock according to one preferred embodiment of the present invention; and FIG. 3 is another schematic view showing the assembly of the image capturing device having an expansion dock according to one preferred embodiment of the present invention.

As shown in figures, the image capturing device having an expansion dock provided by the present invention comprises: an image capturing device 10; an expansion dock 20; a display device 30; a printed circuit board 40; and a drive unit 50.

The image capturing device 10 is, e.g. but not limited to, a digital camcorder or a digital camera, the bottom thereof is installed with a rail 11, and one lateral wall thereof is installed with a first connector 12.

The expansion dock 20 is formed with an accommodation space 21, one side of the bottom is installed with a guide slot 22 allowing the rail 11 to be sleeved therein thereby accommodating the image capturing device 10, and one lateral wall of the expansion dock 20 is installed with a second connector 23 for being connected with the first connector 12, and the other lateral wall 24 of the expansion dock 20 is hollow.

The display device 30 is disposed on the lateral wall 24, wherein the display device 30 is, e.g. but not limited to, a liquid crystal display.

The printed circuit board 40 is disposed in the accommodation space 21 for accommodating components such as the drive unit.

The drive unit 50 is disposed on the printed circuit board 40 and respectively coupled to the display device 30 and the second connector 23, thereby driving the display device 30.

As shown in FIG. 2 and FIG. 3, when the image capturing device 10 and the expansion dock 20 are combined, the image data captured by the image capturing device 10 can be displayed on the display device 30 through connecting the first connector 12 and the second connector 23, thereby achieving an object of real-time viewing.

In addition, the expansion dock 20 provided by the present invention further includes a wireless communication module 60 disposed on the printed circuit board 40 and coupled to the second connector 23 for providing a wireless communication function, wherein the wireless communication module 60 is, e.g. but not limited to, a WiFi communication module or a 3 G communication module. With the installation of the wireless communication module 60, the image data captured by the image capturing device 10 is enabled to be transmit to a computer mainframe (not shown) for the purpose of processing or storing through a wireless means, thereby improving the inconvenience of connecting a transmission cable.

Moreover, the expansion dock 20 provided by the present invention further includes a satellite positioning device 70 disposed on the printed circuit board 40 and coupled to the second connector 23 for providing a global positioning function, such that the image data captured by the image capturing device 10 is enabled to be provided with the latitude where the image capturing is taken place.

Moreover, the bottom of the expansion dock 20 provided by the present invention further includes a support base 25 for being externally connected with a supporter 80. Wherein, the supporter 80 can be held on the support base 25 for supporting the image capturing device 10.

As shown in FIG. 1, the supporter 80 further includes a base 81, a combination frame 82, an engagement unit 83, a rotary button 84 and a lock unit 85. Wherein, the base 81 has two lugs 811, 812, and the lug 811 has a lug hole 813 allowing a lock part 841 of the rotary button 84 to be installed therein, the lug 812 also has a lug hole 814 allowing the lock part 841 of the rotary button 84 to be installed therein and also allowing the engagement unit 83 to be accommodated. The top of the combination frame 82 is installed with a tenon 821, the bottom thereof is formed with a frame hole 822 having plural first combination teeth 823 at its periphery. The engagement unit 83 is formed with an engagement hole 831 with plural second combination teeth 832 corresponding to the first combination teeth 823.

When being assembled, firstly the combination frame 82 is combined with the engagement unit 83, and the engagement unit 83 is provided on the lug 812; then the rotary button 84 is passed through the lug hole 813, the frame hole 822, the engagement hole 831 and the lug hole 814; lastly the lock unit 85 is locked with the lock part 841 of the rotary button 84, thereby finishing the assembly of the supporter 80.

As shown in FIG. 2 and FIG. 3, when the supporter 80 is combined with the expansion dock 20, the tenon 821 is latched on the support base 25 thereby finishing the assembly. When applying an external force to the lateral wall of the combination frame 82, the combination location between the first combination teeth 823 and the second combination teeth 832 can be altered thereby adjusting the forward/backward angle of the expansion dock 20.

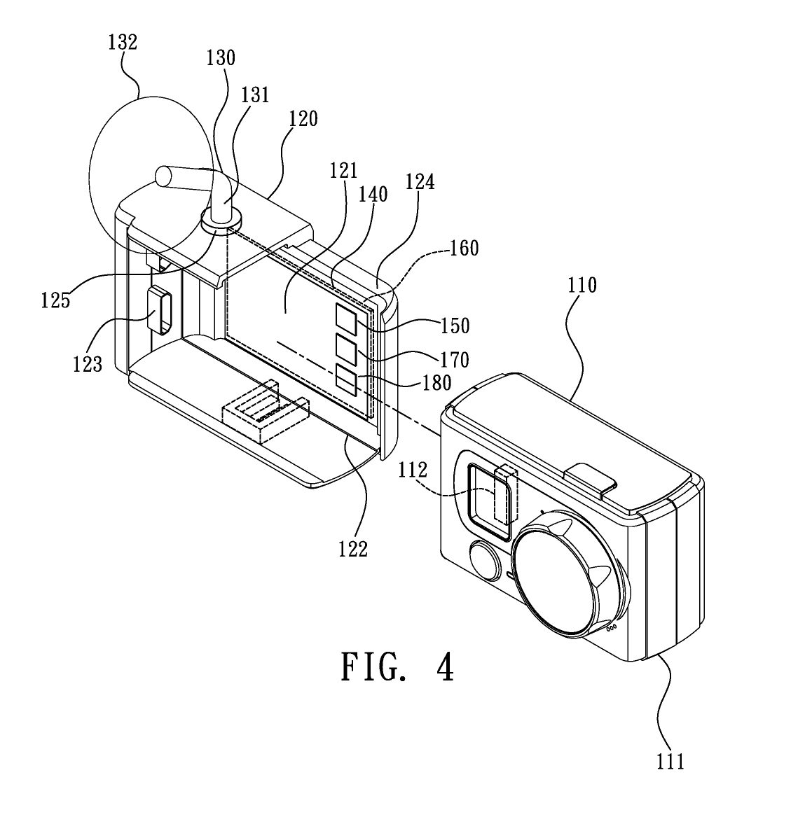

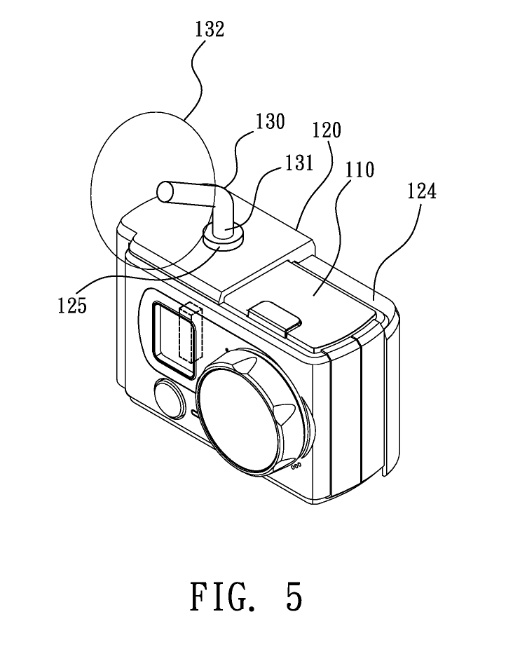

Referring to FIG. 4 and FIG. 5, wherein FIG. 4 is a schematic exploded view showing the image capturing device having an expansion dock according to another preferred embodiment of the present invention; and FIG. 5 is a schematic view showing the assembly of the image capturing device having an expansion dock according to another preferred embodiment of the present invention.

As shown in figures, the image capturing device having an expansion dock provided by the present invention comprises: an image capturing device 110; an expansion dock 120; and a supporter 130.

The image capturing device 110 is, e.g. but not limited to, a digital camcorder or a digital camera, the bottom thereof is installed with a rail 111, and one lateral wall thereof is installed with a first connector 112.

The expansion dock 120 is formed with an accommodation space 121, one side of the bottom is installed with a guide slot 122 allowing the rail 111 to be sleeved therein thereby accommodating the image capturing device 110, one lateral wall of the expansion dock 120 is installed with a second connector 123 for being connected with the first connector 112, and the other lateral wall 124 of the expansion dock 120 is hollow.

One end of the supporter 130 is fastened on the top of the expansion dock 120 through a screw (not shown), the other end is installed with a sucking disc 132, such that the sucking disc 132 can be used to fasten the image capturing device 110 and the expansion dock 120 on, e.g. but not limited to, the glass of a vehicle.

In addition, the expansion dock 120 further includes a printed circuit board 140 and a wireless communication module 150, wherein the wireless communication module 150 is disposed on the printed circuit board 140 and coupled to the second connector 123 for providing a wireless communication function, and the wireless communication module 150 is, e.g. but not limited to, a WiFi communication module or a 3 G communication module.

Moreover, the other lateral wall 124 of the expansion dock 120 is hollow, and the expansion dock 120 further includes a display device 160 and a drive unit 170, wherein the display device 160 is installed on the hollow lateral wall 124, the drive unit 170 is disposed on the printed circuit board 140 and coupled to the second connector 123, wherein the display device 160 is a LCD display device.

Moreover, the expansion dock 120 further includes a satellite positioning device 180 disposed on the printed circuit board 140 and coupled to the second connector 123 for providing a global positioning function.

As shown in FIG. 5, when the image capturing device 110 and the expansion dock 120 are combined with the supporter 130, the image capturing device 110 and the expansion dock 120 can be fastened on the windshield of a vehicle and combined with the display device 160 and the satellite positioning device 180, so the image capturing device 110 provided by the present invention is equipped with the functions of global positioning and satellite navigation. As such, the image capturing device having an expansion dock provided by the present invention is novel compared to the image capturing device which adopts convention arts.

As what is disclosed above, the image capturing device having an expansion dock provided by the present invention is installed with an expansion dock which can be combined with the image capturing device, and the expansion dock has a display device, so the image data captured by the image capturing device can be displayed on the display device; and the expansion dock is installed with a wireless communication module, so the image data captured by the image capturing device can be transmitted through the wireless communication module. As such, the image capturing device having an expansion dock provided by the present invention is novel compared to conventional image capturing devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. An image capturing device having an expansion dock, comprising:
an image capturing device having a rail at the bottom and a first connector on one lateral wall;
an expansion dock formed with an accommodation space, and having a guide slot at one lateral side of the bottom for allowing said rail to be sleeved in thereby accommodating said image capturing device, and one lateral wall of said expansion dock being installed with a second connector for being connected with said first connector, and the other lateral wall of said expansion dock being hollow;
a display device disposed on the other lateral wall of said expansion dock;
a printed circuit board disposed on said expansion dock; and
a drive unit disposed on said printed circuit board and respectively coupled to said display device and said second connector;
thereby enabling the image data captured by said image capturing device to be displayed on said display device through connecting said first connector and said second connector.

2. The image capturing device having an expansion dock as claimed in claim 1, wherein said display device is a liquid crystal display device.

3. The image capturing device having an expansion dock as claimed in claim 1, further including a wireless communication module disposed on said printed circuit board and coupled to said second connector for providing a wireless communication function, wherein said wireless communication module is a WiFi communication module or a 3 G communication module.

4. The image capturing device having an expansion dock as claimed in claim 1, further including a satellite positioning device disposed on said printed circuit board and coupled to said second connector for providing a global positioning function.

5. The image capturing device having an expansion dock as claimed in claim 1, wherein the bottom of said expansion dock further includes a support base.

6. The image capturing device having an expansion dock as claimed in claim 5, further including a supporter capable of being fasted on said support base for supporting said image capturing device.

7. An image capturing device having an expansion dock, comprising:
an image capturing device having a rail at the bottom and a first connector on one lateral wall;
an expansion dock formed with an accommodation space, and having a guide slot at one lateral side of the bottom for allowing said rail to be sleeved in thereby accommodating said image capturing device, and one lateral wall of said expansion dock being installed with a second connector for being connected with said first connector;
a printed circuit board disposed on said expansion dock; and
a wireless communication module disposed on said printed circuit board and coupled to said second connector;
thereby enabling the image data captured by said image capturing device to be transmitted by said wireless communication module through connecting said first connector and said second connector.

8. The image capturing device having an expansion dock as claimed in claim 7, wherein said wireless communication module is a WiFi communication module or a 3 G communication module.

9. The image capturing device having an expansion dock as claimed in claim 7, wherein the other lateral wall of said expansion dock is hollow, and further including a display device and a drive unit, wherein said display device is disposed on the hollow lateral wall, said drive unit is disposed on said printed circuit board and coupled to said second connector, wherein said display device is a LCD display device.

10. The image capturing device having an expansion dock as claimed in claim 7, further including a satellite positioning device disposed on said printed circuit board and coupled to said second connector for providing a global positioning function.

11. The image capturing device having an expansion dock as claimed in claim 7, wherein the bottom of said expansion dock further includes a support base.

12. The image capturing device having an expansion dock as claimed in claim 11, further including a supporter capable of being fasted on said support base for supporting said image capturing device.

13. An image capturing device having an expansion dock, comprising:
an image capturing device having a rail at the bottom and a first connector on one lateral wall;
an expansion dock formed with an accommodation space, and having a guide slot at one lateral side of the bottom for allowing said rail to be sleeved in thereby accommodating said image capturing device, and one lateral wall of said expansion dock being installed with a second connector for being connected with said first connector; and
a supporter with one end fastened on said expansion dock for supporting said image capturing device.

14. The image capturing device having an expansion dock as claimed in claim 13, wherein said expansion dock further includes a printed circuit board and a wireless communication module, wherein said wireless communication module is disposed on said printed circuit board and coupled to said second connector for providing a wireless communication function, wherein said wireless communication module is a WiFi communication module or a 3 G communication module.

15. The image capturing device having an expansion dock as claimed in claim 14, wherein the other lateral wall of said expansion dock is hollow, and further including a display device and a drive unit, wherein said display device is installed on the hollow lateral wall, said drive unit is disposed on said printed circuit board and coupled to said second connector, wherein said display device is a LCD display device.

16. The image capturing device having an expansion dock as claimed in claim 14, further including a satellite positioning device disposed on said printed circuit board and coupled to said second connector for providing a global positioning function.

17. The image capturing device having an expansion dock as claimed in claim 14, wherein said supporter is fastened on the top of said expansion dock through a screw, the other end of said supporter is installed with a sucking disc.
